(19) United States
(12) Patent Application Publication
(10) Pub. No.: US 2008/0071717 A1
(43) Pub. Date: Mar. 20, 2008

(54) Method and system for scenario investigation

(76) Inventors: Motti Nisani, Sedi Hemed (IL); Diamond Tsion Chaflawee, Herndon, VA (US)

Correspondence Address: PEARL COHEN ZEDEK LATZER, LLP, 1500 BROADWAY 12TH FLOOR, NEW YORK, NY, 10036, US

(21) Appl. No.: 11/515,927

(22) Filed: Sep. 6, 2006

(51) Int. Cl. G06N 5/00

(52) U.S. Cl. 706/45

(57) ABSTRACT

According to embodiments of the present invention a computer implemented process for reconstruction of incidents handled by emergency service providers is provided. The method includes retrieving multimedia recorded events containing data related to an incident handled by an emergency service provider from a plurality of incident sources, reconstructing the incident on a client computer, organizing the incident and distributing the organized data.

### BACKGROUND OF THE INVENTION

Emergency service providers also known as first responders, such as fire services, police and emergency medical services must maintain records of all the action they take in dealing with any incident, both for internal review and occasionally before the court. Accordingly, for each incident related telephone calls, radio transmissions, video streams and content of computer screen may be recorded and stored in different storage devices, which may be located in different and remote locations.

Command, Control and Communications Centers (C4) are the focal points for collecting, processing, storing, displaying, analyzing and reacting to data obtained from first responder real-time operations. After an incident is concluded, C4 and/or first responder personnel may require a thorough reconstruction of events using available recorded data together with data from other sources. For an incident involving the intervention of more than one emergency service provider, the reconstruction process requires gathering the data from all providers and converting the raw captured information to a structured form. This process currently involves many non-computerized operations, which are time-consuming and inefficient.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is an exemplary block diagram of an exemplary system including an investigation tool according to embodiments of the present invention;

FIG. 2 is high level diagram illustration of scenario reconstruction and incident investigation tool within a client computer according to embodiments of the present invention;

FIG. 3 is a flow chart diagram illustrating a computer retrieval process directed to reconstruction of an incident (first responder) according to embodiments of the present invention;

FIG. 4 is an exemplary depiction of a portion of a computer screen according to embodiments of the present invention;

FIG. 5 is exemplary depiction of a portion of a computer screen showing the “Add to Organizer” action according to embodiments of the present invention;

FIG. 6 is a flow chart diagram illustrating a computer organizing process within the organizer module according to embodiments of the present invention; and

FIG. 7 a flow chart diagram illustrating a computer distributing process for distributing incident material as evidence according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Embodiments of the present invention are directed to a computer-implemented process for scenario reconstruction and incident investigation of incidents handled by one or more emergency service providers, also known as first responders. First responders are organizations and personnel that provide law enforcement, safety and protection services to the public. A non-exhaustive list of examples for first responders includes law enforcement officers like police, sheriff, highway patrol, detectives, special law enforcement, military personnel, border patrol, and others. First responders also include fire and safety personnel, for example, firefighters, emergency medical services personnel and other emergency workers. First responders are constantly on duty, may be called out at any hour of the day or night, and respond to every call from the public. Throughout the specification and claims the terms emergency service providers and first responders are interchangeably used.

Throughout the specification and the claims the term “incident” refers to a collection of events which may be associated with recorded sessions and data. The incident may include several types of recorded sessions and additionally data related to the location of first responder staff confined to a certain period of time and to one or more specific locations. An incident usually includes many events, wherein each event is associated with a single recorded session.

After an incident is concluded, first responder personnel may utilize the investigation tool according to embodiments of the present invention to perform scenario reconstruction and incident investigation in a quick and efficient manner. Embodiments of the present invention may provide a platform for combining in synchronization various types of recorded media directed to an incident handled by one or more emergency service providers.

A non-exhaustive list of examples of types of media handled within the platform provided by embodiments of the present invention includes, telephony audio, radio audio, data related to the events, video recordings, computer screen recordings, GIS track information, and others. The GIS track information may include Automatic Vehicle Location (AVL) information of car fleets. Each of these media may be recorded on one or more separate dedicated recording units (event sources) having specific characteristics and interfaces. Additionally, each event source is usually associated with one emergency service provider.

According to embodiment of the present invention, a user may retrieve multimedia information from various data resources for a computer-implemented process of scenario reconstruction with user-friendly display and manipulation capabilities. The reconstruction may include displaying events on a single screen and replaying synchronized with time selected events. A non-exhaustive list of communication events includes telephony communications, radio communications video recordings, computer screen recording and other data sources.

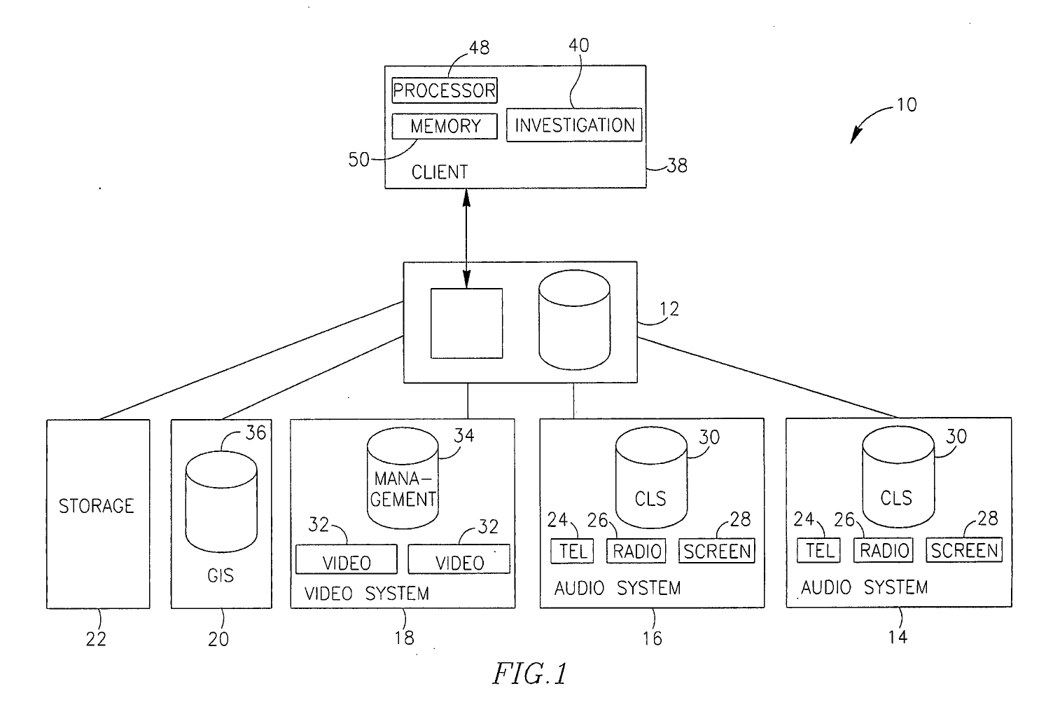

Referring first to FIG. 1, there is shown a block diagram of an exemplary system within which the investigation tool according to embodiments of the present invention may operate. It should be understood to a person skilled in the art that the architecture of the exemplary system described below does not limit the scope of the invention and embodiments of the invention may be implemented in other systems.

A system 10 may comprise a server 12 and a plurality of recording systems 14, 16, 18, a geographical information system (GIS) 20 and storage center 22, all coupled to server 12 and referred to collectively as data resources. It should be understood to a person skilled in the art that although exemplary system 10 includes one server, it does not limit embodiments of the invention in this respect and embodiments of the present invention may be utilized using more that one server. In particular more than one server 12 may be used in a system intended to distribute heavy load of data streams or for multi-site installations.

Recording systems 14 and 16 may be an audio recording system, such as, for example NiceLog® manufactured by Nice Systems Ltd. from Ra'anana Israel. The audio recording system may have one or more recording units, such as an audio telephony recording unit 24 to record telephone calls related to incidents handled by an emergency service provider. Non-limiting examples of such telephone calls may be incoming calls to the emergency telephone number of a an emergency service reporting an incident, telephone calls between a first provider employee during an incident, telephone calls between a civilian and a first provider employee during an incident and others.

The audio recording system may further comprise a radio recording unit 26 to record radio communications. Non-limiting examples of such radio communication may include a group call where a single speaker who is a first responder employee, such as a policeman transmits to a group of listeners belonging to the same group, namely to other policemen; an

individual call in which a first radio user who is an employee of an emergency service provider talks directly to a second radio user; an interconnect call between a radio user and a telephone user and others. It should be noted that additionally data may be transmitted between radio terminals and may be likewise recorded. Optionally, the audio recording system may comprise a screen recording unit 28 to record content of computer screens and others. Audio recording systems 14 and 16 may further comprise a call logging system 30 to control and manage the logging operations. Call logging system may contain data associated with the recorded calls, for example, location of the recorded data associated with the call (event data) within recording unit 24, telephone number, duration of the call, automatic number identification (ANI), automatic location identifier (ALI) and other data. The event data may be supplied via a CTI feed, processed and stored in a database.

Although in the exemplary system depicted in FIG. 1, only two audio video systems are described, it should be understood to a person skilled in the art that embodiments of the invention are not limited in this respect and the number of audio recording systems may vary. It should also be understood to a person skilled in the art that recording systems 14 and 16 may both be used for recording audio from calls and radio handled by the same emergency provider. Alternatively, each recording system may records calls and radio from different emergency service providers.

Recording system 18 may be a video recording system, such as, for example NiceVision® manufactured by Nice Systems Ltd. from Ra'anana Israel. The video recording system may comprise one or more video recording units 32 to record video received from video sensors and a management unit 34 to control and manage the recording and logging operations. GIS 20 may comprise GIS logger 36 containing GIS data, such as maps and other spatial interpretation and outputs. Storage center 22 may comprise archived data from the recording units and data from other external sources.

A client computer 38 may be coupled to server 12 via a communication network. Client computer may include an incident investigation tool 40, one or more processors 48 and a memory 50. Computer 38 may further include connection (not shown) to external devices such a keyboard, a mouse and the like and output devices such as speakers, a screen and the like. Client computer 38 may initiate, using investigation tool 40, a search related to a specific incident handled by one or more emergency service provider using predefined parameters in one or more of the data resources. A list of search parameter may be delivered by client 38 to server 12 for each type of recording system or data resource which is to be searched. Server 12 may then issue individual searches for the required data resources. The results are sent from the individual data resources 14-22 to server 12 for filtering and removing those results that client 38 may not have the privilege to access. The remaining results may be sent separately to client 38 for display.

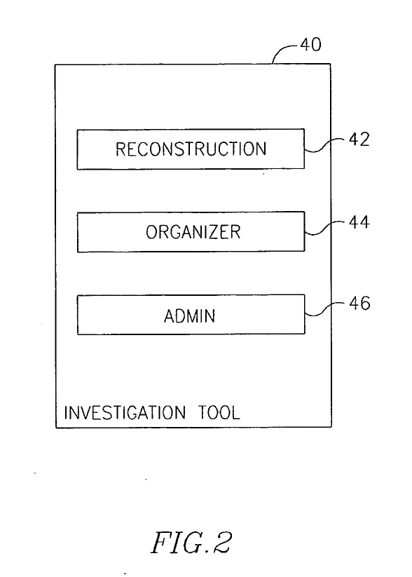

Reference is now made to FIG. 2, which is a high level diagram illustration of scenario reconstruction and incident investigation tool within a client computer according to embodiments of the present invention.

Investigation tool 40 may comprise a reconstruction module 42, which is a tool based on recreation of multimedia information available at the time and scene of an incident, an organizer module 44 to gather incident-related information for management and distribution and system administration modules 46, which may include user privileges administration and system administration.

Reconstruction module 42 may be referred to as a scenario investigation and debriefing tool. Reconstruction module 42 may enable authentic re-creation of all information actually available at the time and scene of the incident. Each event that took place during an incident may be identified by the exact time of its occurrence. Non-limiting examples of an event may include radio and telephony communications, video, CAD screen recordings and GIS maps, all related to an incident handled by one or more first responders.

The main features in reconstruction module 42 may include initiate searching databases containing multimedia data associated with incidents and filtering the search results according to predetermined parameters; enabling of time-synchronized replay of multimedia incident recordings; graphical presentation of incident multimedia information sorted on a time scale; graphical presentation of incident multimedia information sorted according to user's definitions; additional presentation of incident multimedia information in a table format; presentation SDS messages, session information and other recording details according to user's definitions; and categorization of sessions for focused investigation (for example, coloring in red all radio transmissions associated with firefighters)

Reconstruction module 42 may further comprise additional features like playback controls including advanced playback features as spoken date and time, automatic gain control (AGC), noise reduction, speed control (with pitch correction), loop replay and more; enablement of volume control per channel; text annotation speech annotation and time-position indicator to selected sessions; and wrap-up of all incident related information into an incident folder for further manipulation.

Organizer module 44 may serve as a central location on client computer 38 to hold incident information and to manage its distribution to external parties. Organizer module 44 may enable the user to construct incident folders and fill these folders with any related material (voice, video, screen recording) captured by recording systems 14-18 and additionally material created by other systems, such as for example associated police reports, which may be imported to client 38. The organizer module may additionally enable control of distributing copies of incident-related information to third parties, such as for example courts, lawyers and others.

The main features in organizer module 44 may include organizing incident information in folders which may contain both multimedia sessions captured by recording system and other files created by other systems and imported into client 38; associating to the retrieved data an incident number, a file number and other reference numbers for identification and quick lookup; wizard-based process for creation and distribution of copies of incident materials for presentation in court or otherwise; proof of authenticity of the copies of the incident materials using digital signature; transcription of audio recordings; and history log of actions related to incident information management.

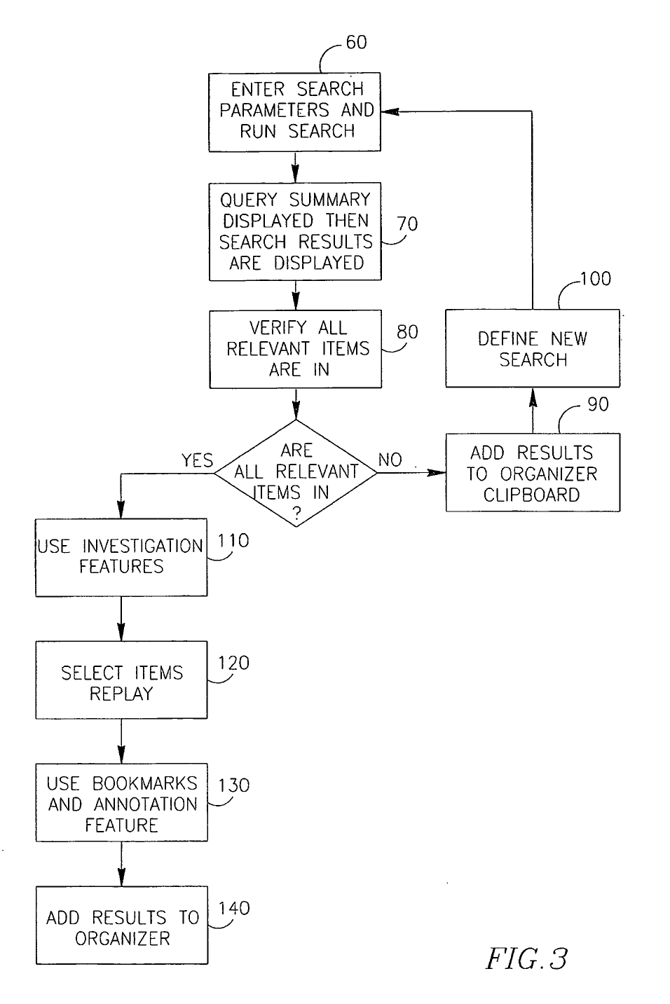

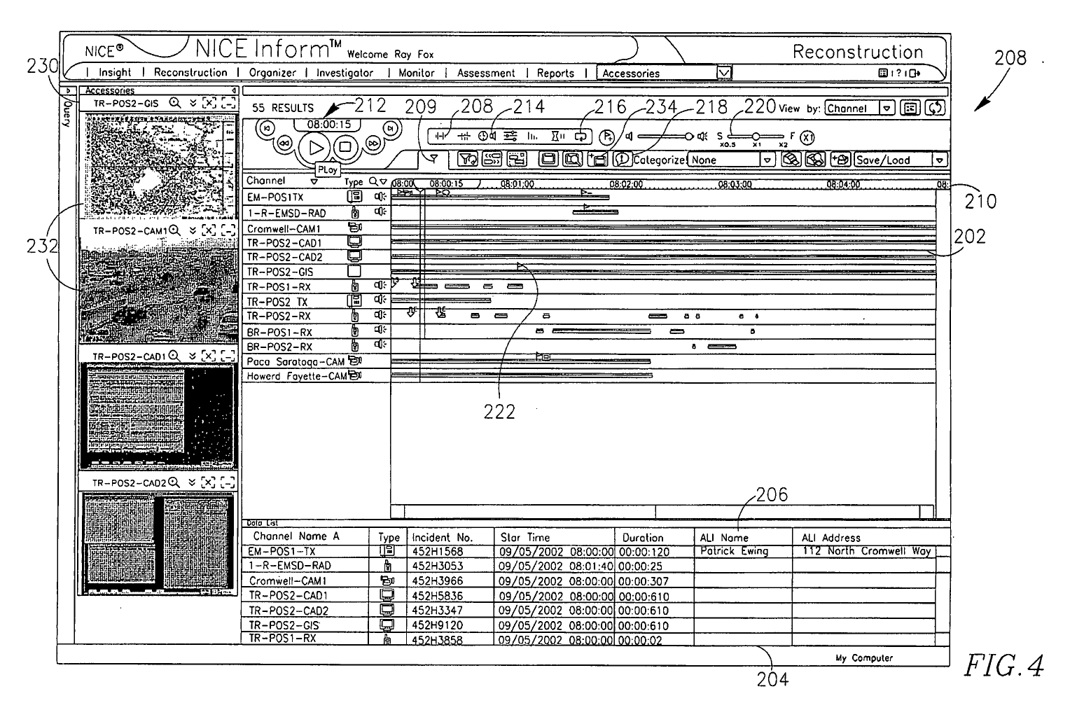

Reference is made to FIG. 3, which is a flow chart diagram illustrating a computer retrieval process directed to reconstruction of an incident (first responder) according to embodiments of the present invention. Reference is additionally made to FIG. 4 which is an exemplary depiction of a portion of a computer screen showing the multimedia items retrieved from various data resources according to embodiments of the present invention.

First, as shown in box 60, to initiate the process of searching for related incident items (events), the user may enter search parameters and may run a search utilizing reconstruction module 42. Non limiting examples of search parameters may include date and time of desired incident, incident number, position number, channel name, Calling Line identification (CLI) and others. The user may then activate the search based on the search parameters for retrieval of events related to the desired incident from the various recording systems 14-20.

The query summary including the entered search parameters and information related to the search progress may be displayed while the retrieval is being processed. The user may choose to cancel the query or save it. The search may be streamed to client 38 until the retrieval is terminated (box 70). The search results may be displayed in both graphical view 202 and table view 204 as can been seen in FIG. 4. The display in the graphical view may be sorted according to the user preferences.

Table view 204 may include a title bar 206 having a plurality of segments, each associated with the column below it. Below the “Channel Name” segment, a list of all retrieved events is shown. The “Type” column represents icons, each representing the type of media its respective event is associated with. The “Incident No.” column displays identification numbers, each assigned to its respective event. Other columns include “Start time” indicating the time the event has begun, “Duration” indication the duration of the recorded event, “ALI name” indicating the name of a caller and “ALI address” indicating the address of the caller. It should be understood to a person skilled in the art that according to embodiments of the present invention, other identifiers may be displayed in table view 202 and the embodiment illustrated in FIG. 4 does not limit the present invention.

Graphical view 202 may include a toolbar 208 and a time-line 210 divided into several intervals. Toolbar 208 may provide a plurality of convenience tools including playback tool 212, talking clock tool 214, loop replay 216, information balloon 218, volume-control-per-channel tool 220. A non-exhaustive list of additional tools may be a categorization tool, zoom and a graphical icon to represent the entry source in the graphical view.

In the exemplary embodiment of FIG. 4, various items of information are provided for each recorded event. The search results may include flags 222, which may be automatically generated in the system. Non-limiting examples of a flag include word spotting, a video analysis trigger and ALI/ANI information. Bookmark flags may also be displayed if the user has previously set them.

The user may then want to replay at least a portion of the search result and/or visually review the display to verify the relevancy of the retrieved items (box 80). If not all relevant items are included in the search results as displayed on the screen, the user may save the retrieved results in a new folder (box 90) and may defined a new search (box 100). If all relevant items are included in the search results as displayed on the screen, the user may immediately apply the investigation features on the retrieved data (box 110) or alternatively save the results for later usage of the investigation features. Non-exhaustive list of investigation feature include a filter 209, an information balloon 218, a talking clock 214, volume control for each channel 220, a loop replay 216, a wait control, zoom and categorization.

The user may select all or a portion of the items presented on the screen for replay (box 120). According to embodiments of the present invention, the selected screen and video recording items may be displayed automatically upon activation of the playback option in the first available display window 232 in the accessories pane 230. If none of the display windows are available a new display window may be opened. Alternatively, the user can drag the respective channel entries one by one to an available empty display window in accessories pane 230 before the playback option is activated. Once the playback option is activated the selected item is displayed/replayed and the user may manipulate it using the relevant investigation features. If none of the items is selected before activation the playback option, then all items are replayed synchronously.

The user may use bookmarks and other information features for further reference (box 130). By using a bookmark, text annotation and or/speech annotation the user may mark a specific time zone within the incident chain. Usually, the marked areas are those the user perceives as having importance and relevancy to the review and investigation of the incident.

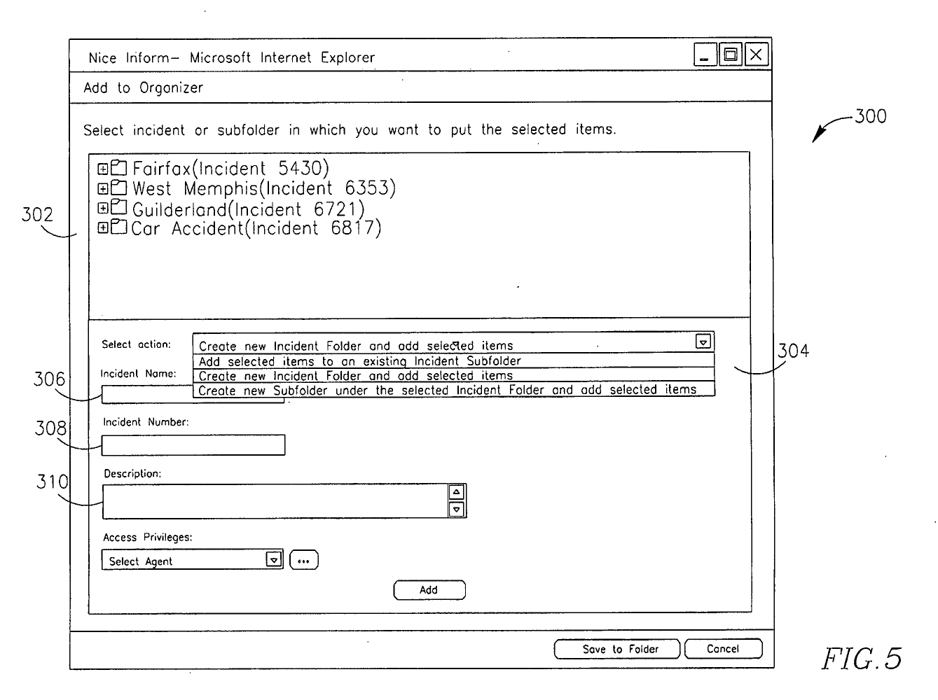

Upon completing the incident review the user may save at least a portion or the manipulated or original items within a new scenario folder to be further managed from the organizer module (box 140). This is done using the add-to-organizer tool 234 (see FIG. 4). Alternatively, the user may add the chosen items to an existing scenario folder. According to embodiments of the present invention, this operation may be performed using a pre-designed window, such as the exemplary window depicted in FIG. 5.

FIG. 5 is an exemplary depiction of a portion of a computer screen showing the “Add to Organizer” action according to embodiments of the present invention. The upper part 302 of the screen 300 shows a list of incident names. The middle part 304 of screen 300 shows the actions the user may select: creating a new incident folder, creating a new incident subfolder or adding the selected items to an existing incident folder. The user may fill in box 306 the incident name from the list appearing at upper part 302 or a new incident name. The incident name may serve as the folder name. The user may fill in box 308 the incident number and in box 310 a free text description of the content of the file for future reference. Additionally, the user may grant other user access privileges.

Once the “Add to Organizer” action is completed, the user may switch to the organizer module from which it may be possible to view the incident folder items in a graphical view and to further manage the incident folder.

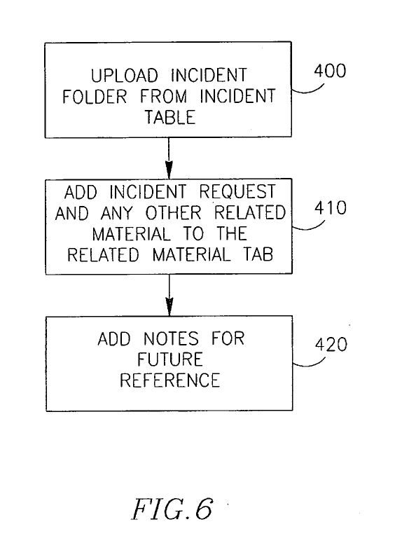

Reference is made to FIG. 6, which is a flow chart diagram illustrating a computer process within the organizer module according to embodiments of the present invention.

First, the user may upload a chosen incident folder from an incident table which includes a list of incident folders (box 400) optionally; the user may add additional material to the folder (box 410). The user may browse and select relevant files saved in client computer 12 in any format such as WORD, ADOBE and any other format. These files may contain related interview, lab results, medical files, and others.

Optionally, the user may add notes describing for example the last action taken or instructions related to the management of the incident information in a dedicated tab within the organizer module display (box 420). It should be understood to a person skilled in the art that the order of the operations described in boxes 410 and 420 may vary according to the user's preferences.

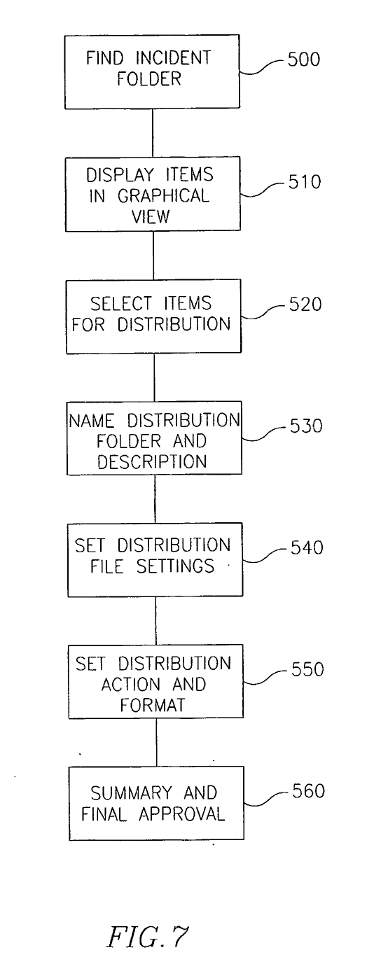

The investigation tool according to embodiments of the present invention may further enable distribution of the entire incident material or only selected items in an easy and efficient manner. Reference is now made to FIG. 7, which is a flow chart diagram illustrating a computer process for distributing incident material as evidence according to embodiments of the present invention.

First, the user may use the organizer module to find the incident folder, which should be distributed (box 500). The user may locate the incident folder from a table listing all incident folders. Alternatively, the user may perform a search based on predefined search parameters. Non-limiting list of search parameters may include incident number, incident search, creator of folder, description and others. Optionally, if the user is interested in verifying the content of the material before distributing it, he may display the items in graphical view (box 510). Then, the user may select the item for distribution (box 520). Once all relevant items are selected, the user may replay the selection in order to verify the content before starting the distribution task.

Next, the user may activate a distribution wizard to start a four-step distribution process. Firstly, the user may assign a name for the distribution task (box 530), which may be used as a subfolder within the relevant incident folder. This subfolder may contain items records distributed for follow-up purposes. The user may also add a description to describe the content of the distribution task for future reference in a special “description” field. Secondly, the user may determine the distribution settings (box 540).

The user may select a predetermined profile of setting for cases in which the incident material is distributed to a known party or parties whose preferences are known to the evidence creator. Alternatively, the user may create manually any setting from a list of predetermined settings. Next, the user may set and format the distribution action (box 550). The user may select the file format and the media type, which will be used for the distribution file. Material including both audio and video/screen recording may be combined into one single file to be replayed in synchronized mode. Next, a distribution summary is created for the final approval of the user before distribution (box 560).

At this stage the material is ready for distribution. A summary including a list of all items selected, distribution folder name, setting and action and other definitions made may be presented for the final review. The user may change any of the definitions as desired or repeat one or more of the previous operations. The user may seal the file once concluded as ready for distribution. A sealed distribution file or folder is prepared to be used in court and/or by attorneys and investigators.

As well known in the art, for distribution purposes, the sealed file may be embodied on any of a variety of known media, such as CD-ROM or tape, or may be distributed over a network to other computer systems.

It should be noted that the Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A computer implemented method for reconstruction of incidents handled by emergency service providers, the method comprising:
retrieving recorded events containing data related to an incident handled by an emergency service provider from a plurality of incident sources, said incident sources are selected from at least a voice recording unit and a video recording unit;
displaying, on a display screen coupled to said computer, a list of identifiers of said recorded events;
reconstructing said incident by replaying at least a portion of at least one of said recorded events;
manipulating at least a portion of at least one of said recorded events; and
organizing said incident by creating a new folder including at least a portion of at least one of said recorded events.

2. The method of claim 1 comprising:
distributing said folder.

3. The method of claim 1, wherein replaying comprises replaying in synchronization at least portions of at least two of said recorded events.

4. The method of claim 1, wherein manipulating comprises editing at least a portion of at least one of said recorded events.

5. The method of claim 1, wherein manipulating comprises adding annotation to at least a portion of at least one of said recorded events.

6. The method of claim 1, wherein retrieving said recorded events comprises retrieving recorded telephone communication, recorded radio communication, recorded video, recorded computer screen or recorded geographical information.

7. A computer system for of incidents handled by emergency service providers, the system comprising:
a computer coupled to a network;
a memory;
one or more sequences of computer program instructions stored in the memory which, when executed, cause the computer to perform the following:
in response to a query performed by a user, retrieving recorded events containing data related to an incident handled by an emergency service provider from a plurality of incident sources coupled to the network, said incident sources are selected from at least a voice recording unit and a video recording unit and displaying, on a display screen coupled to said computer, a list of identifiers of said recorded events; and
in response to instructions received by the user, replaying at least a portion of at least one of said recorded events, manipulating at least a portion of at least one of said recorded events; and creating a new folder including at least a portion of at least one of said recorded events.

8. The method of claim 7, wherein replaying comprises replaying in synchronization at least portions of at least two of said recorded events.

9. The method of claim 7, wherein manipulating comprises editing at least a portion of at least one of said recorded events.

10. The method of claim 7, wherein manipulating comprises adding annotation to at least a portion of at least one of said recorded events.

11. The method of claim 7, wherein retrieving said recorded events comprises retrieving recorded telephone communication, recorded radio communication, recorded video, recorded computer screen or recorded geographical information.

12. A computer-readable medium storing computer-readable code, which when executed by a computer, causes said computer to:
retrieve recorded events containing data related to an incident handled by an emergency service provider from a plurality of incident sources, said incident sources are selected from at least a voice recording unit and a video recording unit;
display, on a display screen coupled to said computer, a list of identifiers of said recorded events;
reconstruct said incident by replaying at least a portion of at least one of said recorded events;
manipulating at least a portion of at least one of said recorded events; and
organize said incident by creating a new folder including at least a portion of at least one of said recorded events.
